(19) United States
(12) Patent Application Publication
(10) Pub. No.: US 2014/0102379 A1
(43) Pub. Date: Apr. 17, 2014

(54) OFF-LEASH ANIMAL AUTHORIZATION METHOD AND SYSTEM

(71) Applicant: Sebastian Yoon, Calgary (CA)

(72) Inventor: Sebastian Yoon, Calgary (CA)

(21) Appl. No.: 14/056,024

(22) Filed: Oct. 17, 2013

Related U.S. Application Data
(60) Provisional application No. 61/714,843, filed on Oct. 17, 2012.

(51) Int. Cl. A01K 29/00

(52) U.S. Cl. CPC A01K 29/00
USPC 119/712

(57) ABSTRACT

The present invention relates to an area animal authorization system and method for allowing in designated areas only certified animals having indicators that correspond with certain behavioral characteristics and/or training proficiency. The method includes the steps of providing at least one signage at an area, wherein the signage has a signage indicator. Assessing the animal for behavioral characteristics and/or training proficiency. A requestor will then request an animal indicator from an entity, and then the entity will issue an animal indicator based on the animal's assessment. Thereafter, the animal is authorized to access the area if the signage indicator corresponds with the animal indicator issued to the animal. The animal indicator can be a tag; an element attached to a tag; a color; a leash; or an information card, and can be partially or entirely colored.

### CROSS-REFERENCE TO RELATED APPLICATION

This application is an U.S. non-provisional utility application under 35 U.S.C. §111(a) based upon co-pending U.S. provisional application 61/714,843 filed on Oct. 17, 2012. Additionally, this U.S. non-provisional utility application claims the benefit of priority of co-pending U.S. provisional application 61/714,843 filed on Oct. 17, 2012. The entire disclosure of the prior application is incorporated herein by reference.

### FEDERALLY SPONSORED RESEARCH

Not applicable

### SEQUENCE LISTING OR PROGRAM

Not applicable

### BACKGROUND OF THE INVENTION

1. Field of the Invention

The present invention relates to an off-leash animal authorization method and system for use in connection with allowing in designated areas only certified animals having indicators that correspond with certain behavioral characteristics and/or training proficiency.

2. Description of the Prior Art

Off-leash animal authorization method and systems are desirable to provide a safe and stress free environment for people to use and enjoy private and public areas with off leashed animals, such as dogs. In the past several years, there have been 30 to 35 fatal dog attacks in the USA annually. Based on data collected in the USA between 2001 and 2003, the Center for Disease Control (CDC) determined that there are 4.7 million dog bite victims per year. Emergency rooms have seen more than 386,000 dog bite victims annually, and approximately 800,000 dog bite victims receive some form of medical attention; half of which are children. Of those victims seen in emergency rooms, about 16 die, as per the CDC study.

Many municipalities have designated certain areas as off-leash dog parks, and these parks do not discriminate by breed, behavior or training of dogs. Thus allowing all dogs to roam freely within the park area and in proximity with the general public using the park. Many people are fearful of dogs, especially off-leashed dogs, because of the possibility of being bitten or aggressively confronted. These people will thereby not utilize the public area or park which is paid for in part by taxes. Additionally, people with smaller dog breeds, injured dogs and/or elderly dogs, might not utilize off-leash dog parks because of the possibility of an aggressive dog confronting their dog. Consequently, many people are inadvertently victimized and discriminated against, because they decide to not utilize certain public areas in fear of being bitten or their dog being bitten or trampled.

The use of animal indicators and methods of registering an animal is known in the prior art, however the prior art does not solve the above-identified problem. While dog aggressiveness indicators are known, these dogs are still allowed to enter off-leash parks. Even the aggressive dog has an indicator warning that the dog maybe aggressive, these prior art system do not prevent the dog from roaming free in an off-leash park and does not provide a safe state of mind to the general public. While the above-described devices fulfill their respective, particular objectives and requirements, the aforementioned patents do not describe an off-leash animal authorization method and system that allows for the authorization of only certified animals having indicators that correspond with certain behavioral characteristics and/or training proficiency entry into designated areas.

Therefore, a need exists for a new and improved off-leash animal authorization method and system that can be used for allowing in designated areas only certified animals having indicators that correspond with certain behavioral characteristics and/or training proficiency. In this regard, the present invention substantially fulfills this need. In this respect, the off-leash animal authorization method and system according to the present invention substantially departs from the conventional concepts and designs of the prior art, and in doing so provides an apparatus primarily developed for the purpose of allowing in designated areas only certified animals having indicators that correspond with certain behavioral characteristics and/or training proficiency.

### SUMMARY OF THE INVENTION

In view of the foregoing disadvantages inherent in the known types of animal indicators and methods of registering an animal now present in the prior art, the present invention provides an improved off-leash animal authorization method and system, and overcomes the above-mentioned disadvantages and drawbacks of the prior art. As such, the general purpose of the present invention, which will be described subsequently in greater detail, is to provide a new and improved off-leash animal authorization method and system and method which has all the advantages of the prior art mentioned heretofore and many novel features that result in an off-leash animal authorization method and system which is not anticipated, rendered obvious, suggested, or even implied by the prior art, either alone or in any combination thereof.

To attain this, the present invention essentially comprises an area animal authorization method for allowing in designated areas only certified animals having indicators that correspond with certain behavioral characteristics and/or training proficiency. The method includes the steps of providing at least one signage at an area, wherein the signage has a signage indicator. Assessing the animal for behavioral characteristics and/or training proficiency. Requesting an animal indicator from an entity, and then issuing an animal indicator based on the animal's assessment. Then, allowing the animal access in the area if the signage indicator corresponds with the animal indicator issued to the animal.

The animal can be assessed by a person certified to identify behavioral characteristics or training proficiency of the animal. The entity is a federal, state, provincial or municipal body that has the authority to issue and enforce laws regulating animals.

There has thus been outlined, rather broadly, the more important features of the invention in order that the detailed description thereof that follows may be better understood and in order that the present contribution to the art may be better appreciated.

The invention may also include a colored animal indicator that is attachable to a peripheral edge of an animal tag. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved off-leash animal authorization method and system that has all of the advantages of the prior art animal indicators and methods of registering an animal and none of the disadvantages.

It is another object of the present invention to provide a new and improved off-leash animal authorization method and system that may be easily and efficiently manufactured, marketed and implemented.

An even further object of the present invention is to provide a new and improved off-leash animal authorization method and system that has a low cost of manufacture with regard to both materials and labor, and which accordingly is then susceptible of low prices of sale to the consuming public or entity, thereby making such off-leash animal authorization method and system economically available to the buying public or entity.

Still another object of the present invention is to provide a new off-leash animal authorization method and system that provides in the apparatuses and methods of the prior art some of the advantages thereof, while simultaneously overcoming some of the disadvantages normally associated therewith.

Lastly, another object of the present invention is to provide an off-leash animal authorization method and system for allowing in designated areas only certified animals having indicators that correspond with certain behavioral characteristics and/or training proficiency. This allows for people to utilize public and private areas without fear of aggressive animals, and for allowing an entity to generate revenue by issuing the animal indicators at a fee and for issuing fines to people who violate laws or rules associated with designated area as based on the signage in that area.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an embodiment of the off-leash animal authorization method and system constructed in accordance with the principles of the present invention, with the phantom lines depicting environmental structure and forming no part of the claimed invention.

FIG. 2 is a front planar view of signage embodiments of the present invention.

FIG. 3 is a front planar view of the animal indicator tag of the present invention.

FIG. 4 is a front planar view of the attachable indicator fitted to the animal tag of the present invention.

FIG. 5 is a cross-sectional view of the attachable indicator of the present invention taken along line 5-5 of FIG. 4.

FIG. 6 is a cross-sectional view of the attachable indicator fitted to an alternate embodiment animal tag of the present invention.

FIG. 7 is a perspective view of the animal indicator collar of the present invention.

FIG. 8 is a front planar view of the animal indicator information card of the present invention.

FIG. 9 is a flow diagram of the method of the present invention.

FIG. 10 is a schematic diagram of certain computer hardware that may be used to implement the method of the present invention.

FIG. 11 is a flow diagram depicting the steps performed when implementing the method of the present invention.

The same reference numerals refer to the same parts throughout the various figures.

### DETAILED DESCRIPTION OF THE INVENTION

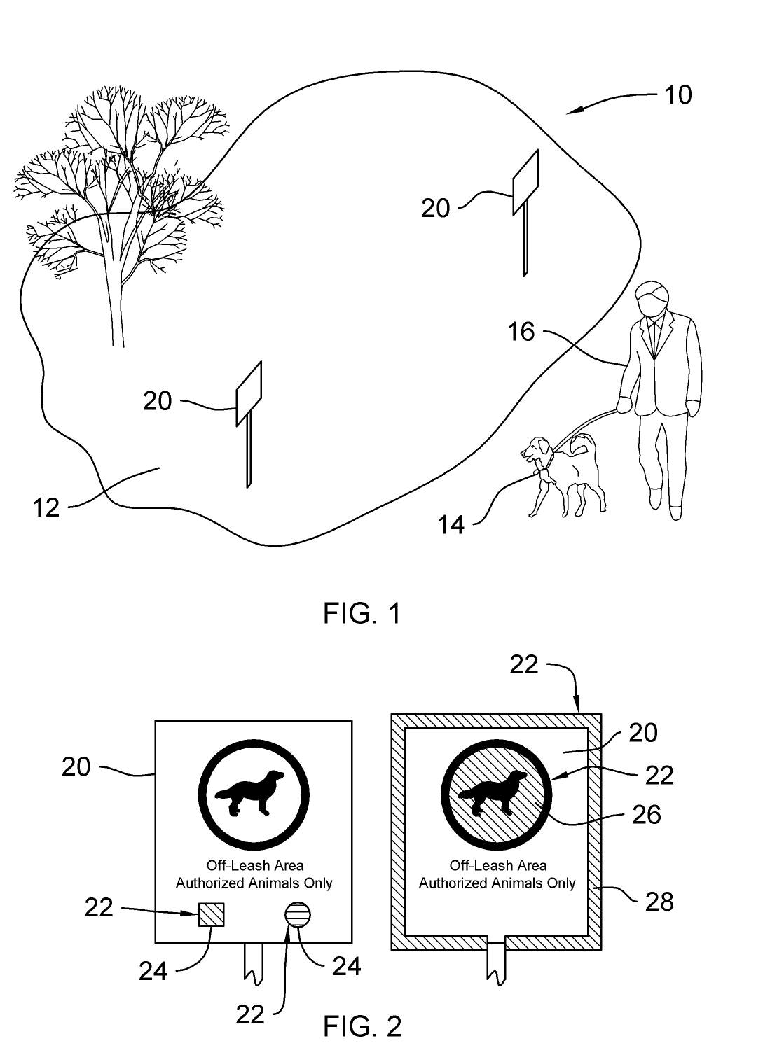

Referring now to the drawings and particularly to FIGS. 1-11, an embodiment of the off-leash animal authorization method and system of the present invention is shown and generally designated by the reference numeral 10.

In FIG. 1, a new and improved off-leash animal authorization method and system 10 of the present invention for allowing in designated areas only certified animals having indicators that correspond with certain behavioral characteristics and/or training proficiency is illustrated and will be described. More particularly, the off-leash animal authorization method and system 10 includes a public or private area 12 designated with signage 20 that indicates which certified animals 14 are authorized to enter or be in the area 12 without any constraints while be accompanied by the animal's handler or owner 16. The present invention provides a safe and stress free environment for people to use and enjoy private and public areas along with off-leashed animals. The present invention provides a safe and stress free environment for small breeds, injured and/or elderly dogs to enjoy the area 12.

The private or public area 12 will include the signage 20 so as to inform people that the area 12 is authorized for certain animals 14 to be off-leashed or without any constraints, thereby allowing the animal 14 to roam free within the area 12. The area 12 can be, but not limited to, private land, private property boundaries, public land, parks, fields, indoor facilities or transportation vehicles.

As best illustrated in FIG. 2, the signage 20 can be supported by any support structure that makes the signage visible by people, and can have any geometrical configuration. One or all sides of the signage 20 will include indicia, text and/or pictures thereon so as to indicate that the area 12 is authorized as an off-leash area for a certain category of animals 14. The signage 20 will also include at least one signage indicator 22 notifying which category of certified animal 14 is authorized to enter and be in the area 12. The signage indicator 22 can be, but not limited to, geometric shapes 24, colored geometric shapes 24, indicia 26 or colored indicia 26. The signage indicator 22 notifies and informs handlers 16 that only animals 14 having an animal indicator 30 corresponding to the signage indicator 22 are authorized to enter or be in the area 12. The signage 20 can include more than one signage indicator 22 so as to authorize more than one category of animal 14 access into the area 12.

Additionally, the signage indicator can be an attachable element 28 configured to be removably and securely attached to any part of the signage 20. The attachable signage indicator element 28 can be, but not limited to, a colored strip having a configuration corresponding to a peripheral edge of the signage 20. The attachable signage indicator element 28 can include a groove configured to securely receive the peripheral edge of the signage 20 therein or can include a latching or locking member that snap fits over the peripheral edge of the signage 20. Furthermore, the color of the attachable signage indicator element 28 may be of more than one color, thereby indicating multiple categories of animals 14 are authorized in the area 12.

The signage indicators 22 are available in different colors that represent the different categories of animals allowed in the area 12, and can be reflective so as to be visible in low light or at night. In an embodiment, the color is selected from, but not limited to, the colors green, blue, amber and red. Additionally, the signage 20 can be incorporated with a fence, barrier or pole (not shown).

For example, the signage indicator 22 can be of varying colors, such as but not limited to, the color green is associated with an animal having a generally stable temperament, calm behavioral characteristics and/or a high proficiency with verbal or visual commands; the color amber is associated with an animal having a generally moderate temperament, moderate behavioral characteristics and/or an average proficiency with verbal or visual commands; the color yellow is associated with an animal having an semi-aggressive temperament, variable behavioral characteristics and/or a low proficiency with verbal or visual commands; and the color red is associated with an animal having an aggressive temperament, unpredictable behavioral characteristics and/or a poor proficiency with verbal or visual commands.

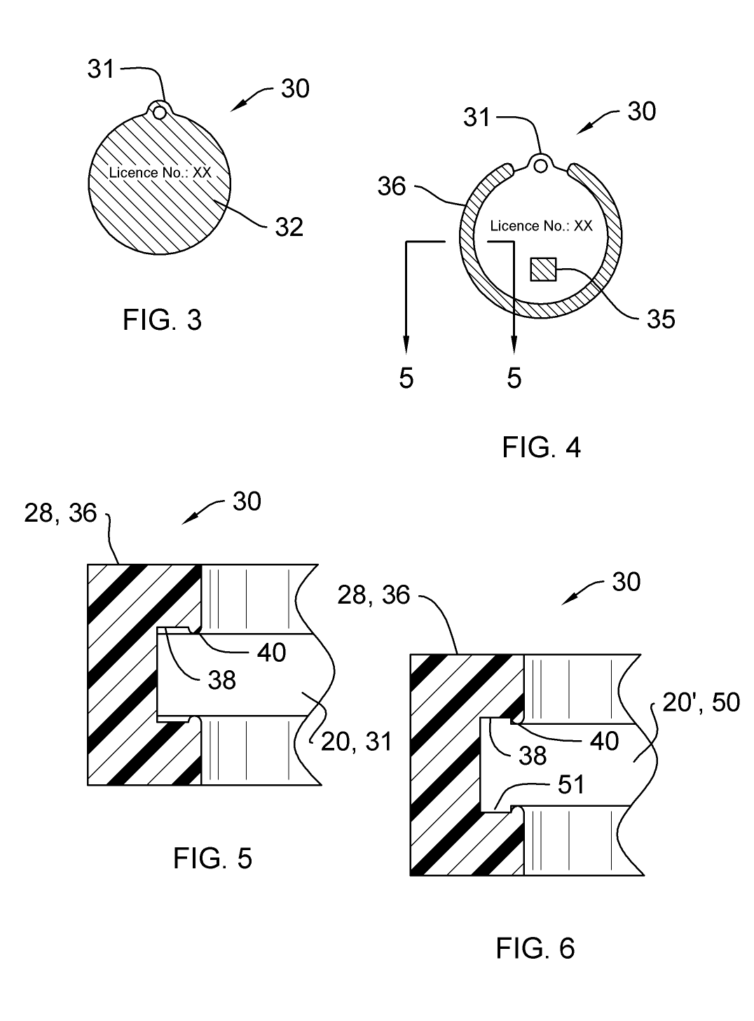

Referring to FIGS. 3-8, the animal indicator 30 can be, but not limited to, an animal tag 31, an attachable indicator element 36, a collar 56, a leash or tether 58 or an information card 60, and will be colored or include indicia which corresponds to the animals 14 behavioral characteristics and/or training proficiency. The animal indicator 30 may also be reflective so as to be visible in low light or at night. The animals 14 behavioral characteristics and/or training proficiency are verified by certified personnel, prior to obtaining the animal indicator 30.

As best illustrated in FIGS. 3 and 4, the tag 31 can be colored 32 or can include geometric indicia, colored geometric indicia or colored indicia 35. In an alternate embodiment, the animal indicator 30 can be an attachable animal indicator element 36. The animal indicator 36 is configured to be removably fitted to the periphery of the tag 31 or to the signage 20. The animal indicator 36 includes a groove 38 configured to receive a peripheral edge of the tag 31, and a projection or flanged section 40 extending from both sides of anterior end of the groove 38. The projections 40 are configured to make contact with the tag 31 and provide a clamping force to both sides of the tag 31 so as to securely attach the animal indicator 36 to the tag 31. The animal indicator 36 can be made from, but not limited to, plastics, metals, alloys, composites, woods, rubbers, and any moldable or extrudeable material.

The animal indicator 36 can be made from a colored material or can be painted a certain color after production. Different colored animal indicators 36 will represent a behavioral and training category of animals. In an embodiment, the color is selected from the colors green, blue, amber and red, such that the colors are associated with the animals 14 behavioral characteristics, disposition and/or training proficiency.

For example and not to be limited by, the color green is associated with an animal having a generally stable temperament, calm behavioral characteristics and/or a high proficiency with verbal or visual commands; the color blue is associated with an animal having a generally moderate temperament, moderate behavioral characteristics and/or an average proficiency with verbal or visual commands; the color amber is associated with an animal having an semi-aggressive temperament, variable behavioral characteristics and/or a low proficiency with verbal or visual commands; and the color red is associated with an animal having an aggressive temperament, unpredictable behavioral characteristics and/or a poor proficiency with verbal or visual commands.

It can be appreciated that alternate embodiment tags and signage can be used with the animal indicator 36, such as a flanged tag 50 or a flanged signage 20′, as best illustrated in FIG. 6. The flanged tag 50 or flanged signage 20′ includes a flanged peripheral edge 51 that is received in a gap formed by the projections 40 of the animal indicator 36 and the sides of the tag 31, 50 or flanged signage 20′. The projections 40 further act as a latching member to the flanged edge 51, thereby further securing the animal indicator 36 to the tag 50 or flanged signage 20′.

Additionally, the animal indicator 36 can have a magnetic section (not shown) so as to be magnetically attached to the tag 31, 50, flanged signage 20′ or to the collar 56.

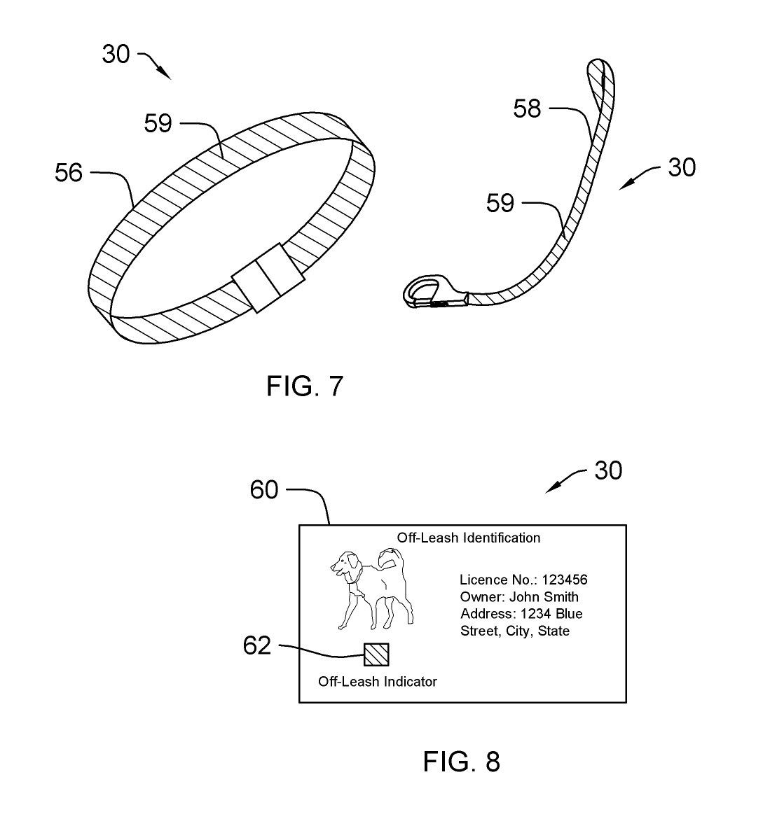

Further alternate embodiments of the animal indicator 30 can be, but not limited to, collars or harness 56, leashes or tethers 58 or animal information cards 60, as best illustrated in FIGS. 7 and 8. The collars 56 and/or leashes 58 are colored or have colored indicia 59 thereon. The animal information cards 60 include geometric indicia, colored geometric indicia or colored indicia 62 thereon, and optional additional information pertaining to the animal or owner.

The color or shape of the animal indicator 30, tag 31, indicia 35, indicator element 36, collar 56, leash 58 or information card indicia 60, will correspond to the animal's 14 behavioral characteristics and/or training proficiency. The color or shape of the signage 20 or indicia 24, 26 on the signage 20 will indicate which category of animal 14 is authorized to enter or be in the area 12. Animals 14 that are in the area 12 and which do not have an animal indicator 30 that corresponds with at least one of the signage indicators 24, 26, will be prohibited from entering the or staying in the area 12. Additionally, laws, by-laws, regulations, ordinances or rules can be implemented to further enforce this prohibition, and the handler or owner 16 may be cited a ticket of a predetermined value for violation of the law.

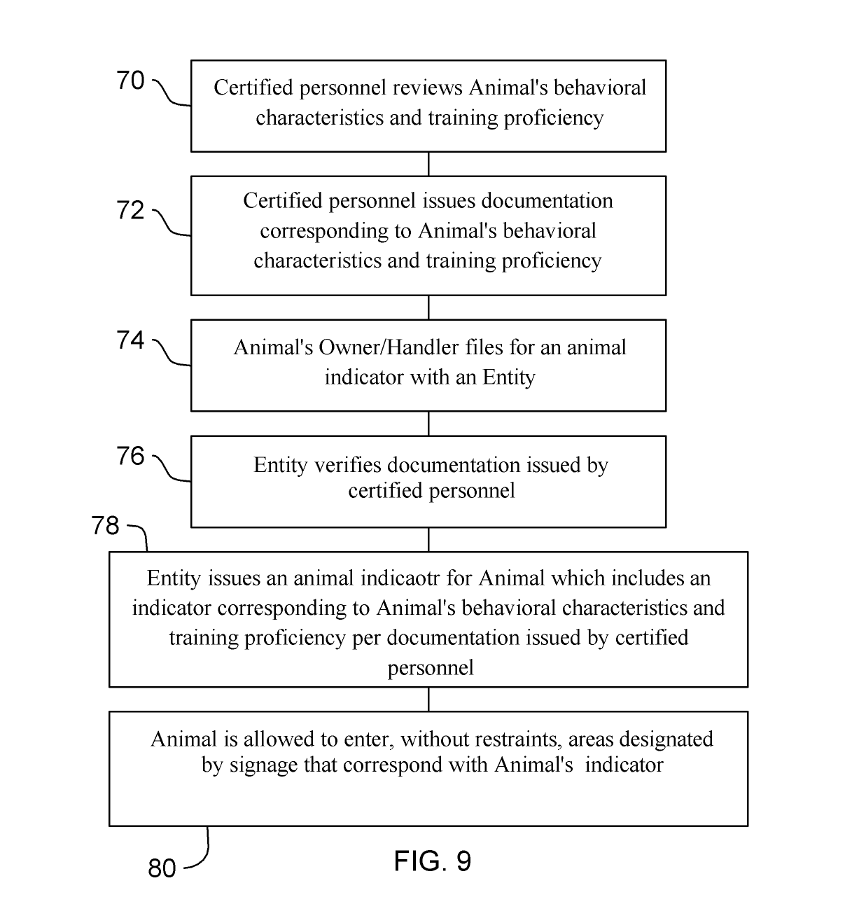

In use, it can now be understood that a method of certifying the animal 14, requesting the animal indicator 30, and then receiving the animal indicator 30 can be used, as best illustrated in FIG. 9. The method of authorizing the animal 14 so as to be allowed entry into the area 12 includes implemented steps 70-80 of having the animal 14 reviewed by certified personnel so as to determine the behavioral characteristics and/or training proficiency of the animal 14. The certified personnel can be, but not limited to, a veterinarian, an animal trainer, an animal handler, an animal breeder, a government employee or any person having a certification that establishes the person has the training to determine animal behavioral characteristics and/or training proficiency.

After reviewing the animal 14, the certified personnel will then assesses the animal's behavioral characteristics and/or training proficiency, and issue documentation to the owner/handler 16 corresponding to the assessment. It can be appreciated that the certified personnel can enter the assessment information into an electronic or computerized system. The documentation includes behavioral characteristics and/or training proficiency information pertaining to the animal, and optionally a behavioral characteristics and/or training proficiency rating. The ratings can be associated with different colors, for example but not limited by, the color green is associated with an animal having a generally stable temperament, calm behavioral characteristics and/or a high proficiency with verbal or visual commands; the color blue is associated with an animal having a generally moderate temperament, moderate behavioral characteristics and/or an average proficiency with verbal or visual commands; the color amber is associated with an animal having an semi-aggressive temperament, variable behavioral characteristics and/or a low proficiency with verbal or visual commands; and the color red is associated with an animal having an aggressive temperament, unpredictable behavioral characteristics and/or a poor proficiency with verbal or visual commands.

The owner/handler 16 can then file for or request an animal indicator from an entity. The entity can be, but not limited to, a federal, state/provincial or municipal body, or a certified third party. The entity then verifies the documentation issued by the certified personnel, and then issues an animal indicator 30 that corresponds to the animal's behavioral characteristics and/or training proficiency as indicated in the documentation. Optionally, entity personnel can review the animal's behavioral characteristics and/or training proficiency information or rating, and thus determine which animal indicator should be issued to the animal.

With the animal indicator 30 attached or provided with the animal 14, the animal 14 is now authorized to enter or be in the area 12 that has a signage indicator 24, 26 matching that of the issued animal indicator 30.

The above method can be used to generate revenue for the federal, state/provincial or municipal body in that the owner/handler 16 will be required to pay a fee for obtaining the animal indicator 30 from the federal, state/provincial or municipal body. The animal indicator can be made valid for a predetermined period, such as one year, which would require the owner/handler 16 to file for a new animal indicator or update their animal indicator every year. Thus resulting in annual revenue for the federal, state/provincial or municipal body in either new filing fees or update fees.

If the animal 14 is issued an animal indicator 30 not satisfactory to the owner/handler 16, then the animal can receive additional training. The owner/handler 16 can have the animal 14 reviewed again by certified personnel, and thus try to get an improved behavioral characteristics and/or training proficiency rating. reapply for an animal indicator from the federal, state/provincial or municipal body. Thereafter, The owner/handler 16 can reapply for a new animal indicator 30 from the federal, state/provincial or municipal body.

Additional revenue can be generated for the federal, state/provincial or municipal body by implementing laws, by-laws, regulations, ordinances or rules toward the access of animals 14 to the area 12, and then enforcing the laws, by-laws, regulations, ordinances or rules. Violation of the laws, by-laws, regulations, ordinances or rules could result in a fine to the owner/handler 16 which would be paid to the federal, state/provincial or municipal body.

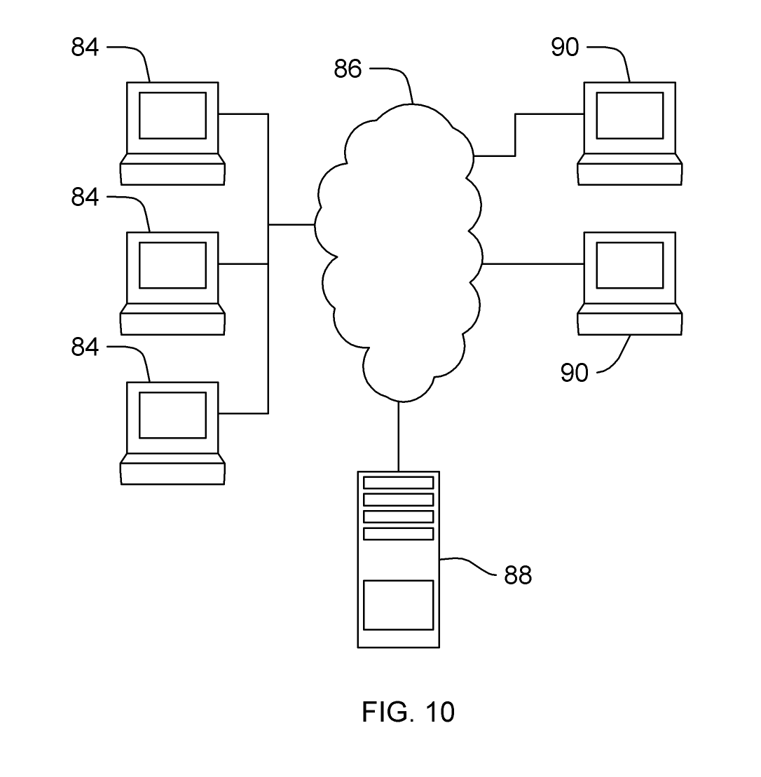

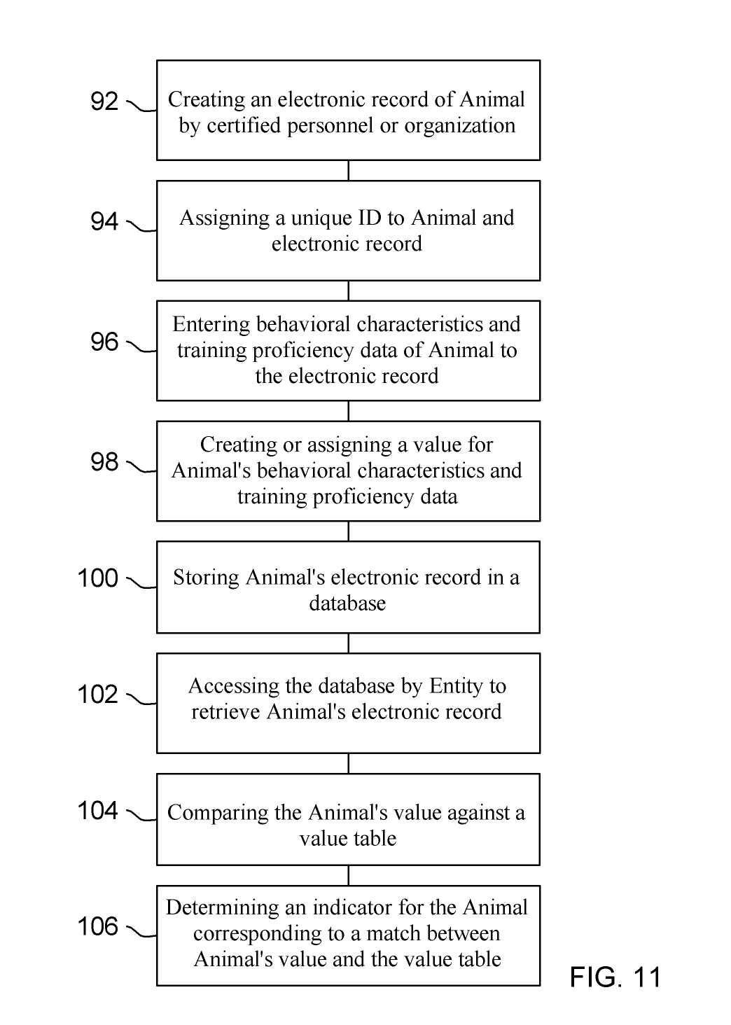

The method can be assisted by the use of computerized devices, as best illustrated in FIGS. 10 and 11, including certified personnel computers 84, database devices or servers 88 and entity computers 90 each being connectable to a network 86. The network 86 can be wired, wireless or the internet. The certified personnel computers 84 and the entity computers 90 can be any computer device including a processor and a display, such as a laptop, a smartphone or a tablet. The computer assisted method includes steps 92-106, as best illustrated in FIG. 11.

The certified personnel computers 84 would include a user interface designed to allow the certified personnel to create an electronic record of the animal 92, and to enter data into the electronic record. The certified personnel computers 84 would also include a data management module which would assign a unique ID 94 to the animal and its electronic record. The data management module would also control the transfer of electronic records to and from the network 86 and database 88. The certified personnel can enter behavioral characteristics and/or training proficiency data 96 pertaining to the animal into the electronic record.

A value is created or assigned to the behavioral characteristics and/or training proficiency data 98 either by the certified personnel computer 84, a module executed in the database 88 or a module executed by the entity computer 90.

The electronic record, and the value if created by the certified personnel computer 84, is then transferred via the network 86 to and stored 100 in the database 88. The electronic record can then be accessed 102 by any certified personnel computer 84 and any entity computer 90.

After the owner/handler 16 requests for the animal indicator 30, entity personnel will access the electronic record of the animal 14 via the unique ID of the animal 14 or the unique ID of the electronic record. A data management module executed by the entity computer 90 will retrieve the electronic record and compare 104 the value against predetermined value data or a data table. The predetermined value data or table associates behavioral characteristics and/or training proficiency values to specific animal indicators 30. The data management module executed by the entity computer 90 or the entity personnel will determine a match 106 between the value and the predetermined value data or data table, and assign an animal indicator 30 for the animal indicator requested by the owner/handler.

The above described method provides for the authorization of certified animals access to certain designated areas without a leash or constraint, while providing a safe state of mind for people utilizing that same area that all the animals in that area are of portray a minimum behavioral characteristic and/or training proficiency. Thus allowing more people to use the area without fear of being bitten, attacked or aggressively confronted by animals. Consequently, the method provides a safe state of mind for owners and handlers of animals that their animal is in a safe area. It can therefore be appreciated that certain areas can also be designated for more aggressive animals, thereby not discriminating these categories of animals.

Additionally, the off-leash animal authorization method and system can be used in certifying specialty animals, such as seeing eye dogs, guard dogs, bomb and drug sniffing dogs, and police dogs.

While embodiments of the off-leash animal authorization method and system have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Although allowing in designated areas only certified animals having indicators that correspond with certain behavioral characteristics and/or training proficiency have been described, it should be appreciated that the off-leash animal authorization method and system herein described is also suitable for authorizing human's access to designated areas.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. An area animal authorization method for allowing in designated areas only certified animals having indicators that correspond with certain behavioral characteristics and/or training proficiency, said method comprising the steps of:
a) providing at least one signage associated with at least one area, wherein said signage having at least one signage indicator;
b) assessing an animal to determine an animal assessment based on one of behavioral characteristics, and training proficiency;
c) requesting an animal indicator from an entity by a requestor;
d) issuing said animal indicator associated with said assessment of said animal; and
e) allowing said animal access in said area if said signage indicator corresponds with said animal indicator issued to said animal.

2. The method as claimed in claim 1, wherein said signage indicator is at least partially colored.

3. The method as claimed in claim 1, wherein said signage indicator has a groove configured to receive a peripheral edge of said signage, and at least one projection configured to contact a surface of said signage.

4. The method as claimed in claim 1, wherein said animal indicator is an animal tag having a colored indicator.

5. The method as claimed in claim 1, wherein said animal indicator is a colored element attachable to an animal tag.

6. The method as claimed in claim 5, wherein said colored element has a groove configured to receive a peripheral edge of said animal tag, and at least one projection configured to contact a surface of said animal tag.

7. The method as claimed in claim 1, wherein said animal indicator is one of a collar, a leash, and an information bearing card, and said animal indicator having at least a portion thereof colored.

8. The method as claimed in claim 1, wherein said animal is assessed by a person certified to identify one of said behavioral characteristics, and said training proficiency of said animal.

9. The method as claimed in claim 1, wherein said entity is one of a federal, state, provincial, and municipal body.

10. The method as claimed in claim 1 further comprising, after said step a), the step of assigning a value to said assessment of said animal.

11. The method as claimed in claim 10 further comprising, after said step c), the step of comparing said value to predetermined values.

12. The method as claimed in claim 11 further comprising, after said step of comparing said value to predetermined values, the step of matching said value to at least one of said predetermined values.

13. The method as claimed in claim 12, wherein said step d) is based on said matched value.

14. The method as claimed in claim 1 further comprising, after said step c), the step of charging a fee to said requestor by said entity, and then collecting payment for said fee.

15. The method as claimed in claim 1 further comprising, after said step e), the step of issuing a fine to a person accompanying said animal if said animal is in said area and if said animal indicator of said animal is different from said signage indicator.

16. An animal area authorization system comprising:
at least one signage having at least one signage indicator, said signage is placed at an area; and
an animal indicator having indicia, said animal indicator being provided with an animal and visibly indicates information pertaining to said animal.

17. The animal area authorization system as claimed in claim 16, wherein said animal indicator is associated with at least one of behavioral characteristics, and training proficiency of said animal.

18. The animal area authorization system as claimed in claim 17, wherein said animal indicator comprises a color.

19. The animal area authorization system as claimed in claim 18, wherein said color is selected from a set of colors representative of at least one of behavioral characteristics, and training proficiency of said animal, each of said colors being associated with a value representative of at least one of behavioral characteristics, and training proficiency of said animal.

20. The animal area authorization system as claimed in claim 19, wherein said colors includes at least a first color, a second color, and a third color, said first color representative of a first value, said second color representative of a second value, and a third color representative of a third value.
